(19) United States
(12) Patent Application Publication
(10) Pub. No.: US 2010/0150560 A1
(43) Pub. Date: Jun. 17, 2010

(54) APPARATUS AND METHOD FOR TRANSMITTING OPTICAL SIGNALS WITH ENHANCED REFLECTION SENSITIVITY IN WAVELENGTH DIVISION MULTIPLEXING PASSIVE OPTICAL NETWORK (WDM-PON)

(75) Inventors: Jie-hyun Lee, Daejeon-si (KR); Seung-hyun Cho, Daejeon-si (KR); Han-hyub Lee, Daejeon-si (KR); Byoung-whi Kim, Daejeon-si (KR); Jea-hoon Yu, Daejeon-si (KR); Sang-soo Lee, Daejeon-si (KR); Jai-sang Koh, Gwangju-si (KR)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Electronics and Communications Research Institute

(21) Appl. No.: 12/625,286

(22) Filed: Nov. 24, 2009

(30) Foreign Application Priority Data
Dec. 12, 2008 (KR) 10-2008-0126811
Mar. 27, 2009 (KR) 10-2009-0026645

(51) Int. Cl. H04J 14/02

(52) U.S. Cl. 398/79

(57) ABSTRACT

Disclosed are an optical transmission apparatus and method in a wavelength division multiplexing passive optical network (WDM-PON). The optical transmission apparatus outputs an optical signal by applying a DC bias current and an RF signal to a laser diode at a threshold current level of the laser diode, thereby broadening an optical spectrum of the laser diode. Accordingly, an optical link becomes less vulnerable to reflection induced noise, which contributes to improve stability and reliability of the optical link.

### CROSS-REFERENCE TO RELATED APPLICATION

This application claims the benefit under 35 U.S.C. §119(a) of Korean Patent Applications No. 10-2008-126811, filed on Dec. 12, 2008 and No. 10-2009-26645, filed on Mar. 27, 2009, the disclosures of which are incorporated by reference in its entirety for all purposes.

### BACKGROUND

1. Field

The following description relates to an optical transmission technology, and more particularly, to an optical transmission technology in a wavelength division multiplexing is passive optical network (WDM-PON).

2. Description of the Related Art

A wavelength division multiplexing passive optical network (WDM-PON) is advantageous in that it can provide personalized, large-capacity communication services to individual subscribers. However, a WDM-PON incurs high costs since optical transmission modules having different wavelength characteristics are needed in correspondence to the number of subscribers.

In order to resolve the problem of high-costs, a loop-back method has been proposed which modulates or re-modulates downlink signals which come from a central office (CO) through a Reflective Semiconductor Optical Amplifier (RSOA) and then returns the modulated or remodulated signals to the CO, without having to provide light sources for individual subscribers.

In the loop-back method, downlink signals to be sent from the CO to a subscriber terminal have to have distinguished wavelengths. For this reason, a reflective semiconductor optical amplifier (RSOA) based on seed-light-injection has been introduced which does not require light sources at a CO side to have different wavelengths while lowering costs and facilitating equipment management.

In the RSOA based on seed-light-injection, the spectrum-sliced light source of a broadband light source (BLS) is used as a seed light source, but the spectrum-sliced light source has limitations in transmission speed and transmission distance of optical signals due to dispersion as the spectrum-sliced light source has a broad optical spectrum.

Accordingly, optical networks have been evaluated to ensure high-speed, long-distance transmission and to utilize a single mode laser to eliminate limitation due to dispersion. A single mode laser may be a distributed feedback laser diode (DFB-LD) array. However, when a single mode laser is used as an optical transmitter, optical links are very vulnerable to reflection induced noise.

### SUMMARY

The following description relates to an apparatus and method for transmitting optical signals in a wavelength division multiplexing passive optical network (WDM-PON) which can control an optical link to be less vulnerable to reflection induced noise.

According to an exemplary aspect, there is provided an optical transmission apparatus including a laser diode to generate an optical signal and use the optical signal as seed light; and a controller to output the optical signal by applying a DC bias current and an RF signal to the laser diode at a threshold current level of the laser diode, thereby broadening an optical spectrum of the laser diode.

According to another exemplary aspect, there is provided a loop-back wavelength division multiplexing passive optical network (WDM-PON) system including: a laser diode to receive a DC bias current and an RF signal, and to output an optical signal at a threshold current level of the laser diode, thereby broadening an optical spectrum; and an optical line terminal including a reflective semiconductor optical amplifier to use the optical signal as seed light and an optical receiver to externally receive an optical signal.

According to another exemplary aspect, there is provided an optical transmission method including: applying a threshold current level of a laser diode; and applying a DC bias current and an RF signal to the laser diode at the threshold current level to broaden an optical spectrum of the laser diode.

Accordingly, since the optical spectrum of a laser diode is broadened to make an optical link less vulnerable to reflection induced noise, the optical link can have high stability and reliability.

Furthermore, by driving the laser diode at a threshold current level to cause the laser diode to operate with RF power, power consumption efficiency can be improved.

Other objects, features and advantages will be apparent from the following description, the drawings, and the claims.

### BRIEF DESCRIPTION OF THE DRAWINGS

FIG. 1 is a configuration view illustrating a central office (CO) of a loop-back wavelength division multiplexing passive optical network (WDM-PON) system according to an exemplary embodiment.

FIG. 2 is a block diagram illustrating an optical transmission apparatus according to an exemplary embodiment.

FIG. 3 is a configuration view illustrating an input controller of the optical transmission apparatus illustrated in FIG. 2.

FIG. 4 is a graph showing optical output with respect to driving current to explain a process of broadening an output spectrum by outputting optical signals at a threshold current level of a laser diode, according to an exemplary embodiment.

FIG. 5 is a circuit diagram illustrating an optical transmission apparatus according to an exemplary embodiment.

FIG. 6 shows a broadened output spectrum according to an exemplary embodiment.

FIG. 7 is a graph showing bit error rate with respect to received power when a laser diode having a broadened optical spectrum is used as a seed light source, according to an exemplary embodiment.

FIG. 8 is a flowchart of an optical transmission method according to an exemplary embodiment.

Elements, features, and structures are denoted by the same reference numerals throughout the drawings and the detailed description, and the size and proportions of some elements may be exaggerated in the drawings for clarity and convenience.

### DETAILED DESCRIPTION

The detailed description is provided to assist the reader in gaining a comprehensive understanding of the methods, apparatuses and/or systems described herein. Various changes, modifications, and equivalents of the systems, apparatuses, and/or methods described herein will likely suggest themselves to those of ordinary skill in the art. Also, descriptions of well-known functions and constructions are omitted to increase clarity and conciseness.

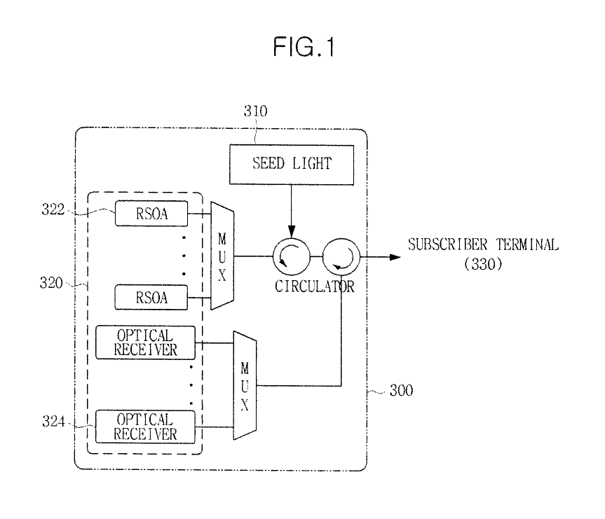

FIG. 1 is a configuration view illustrating a central office (CO) of a loop-back wavelength division multiplexing passive optical network (WDM-PON) system according to an exemplary embodiment.

A WDM-PON, which is a next-generation optical network using WDM, improves expandability and strengthens the vulnerable security of existing Ethernet PONs (EPONs), thus providing high-capacity, high-quality services.

Meanwhile, a loop-back reflective semiconductor optical amplifier (a loop-back RSOA)-based WDM-PON is to modulate or demodulate downlink signals which come from a CO through a RSOA and return the modulated or demodulated signals to the CO, without providing individual optical sources for subscribers.

Referring to FIG. 1, the CO of the loop-back WDM-PON system includes a seed light source 310 and an optical line terminal 320, wherein the optical line terminal 320 includes a RSOA 324 and an optical receiver (RX) 324.

The seed light source 310 may be implemented through spectrum-slicing of a broadband light source (BLS). However, the spectrum-slicing of the BLS has limitations in the transfer rate and distance of signals due to dispersion.

Accordingly, according to an exemplary embodiment, a single mode laser may be used as a seed light source (that is, 310) of uplink or downlink signals. The single mode laser may be a distributed feedback laser diode (DFB-LD) array.

However, when a single mode laser is used as the seed light source 310, optical links may become very vulnerable to reflection induced noise. Accordingly, in order to utilize a single mode laser, it is required to broaden the optical spectrum of a laser diode. Broadening of an optical spectrum includes the concept of broadening the line width of a wavelength spectrum image which appears from the output of a light source.

According to an exemplary embodiment, by broadening an optical spectrum through dithering using RF signals and utilizing a laser diode with the broadened optical spectrum as a seed light source, an optical link becomes less vulnerable to reflection induced noise. Here, dithering means spreading/modulating a frequency to broaden the optical spectrum of optical signal.

Also, according to an exemplary embodiment, a method of driving the laser diode near a threshold current level Ith is used. The threshold current level Ith is a current level at which a light source begins to emit light. Accordingly, near the threshold current level, the optical spectrum of the laser diode can be broadened by using an RF signal having a small magnitude.

Meanwhile, a subscriber terminal 330 includes an optical network unit (ONU) or an optical network terminal (ONT) and receives optical signals from the optical line terminal 320. Also, the WDM-PON may further include a remote node (RN) which relays data between the optical line terminal 320 and ONUs via an optical fiber.

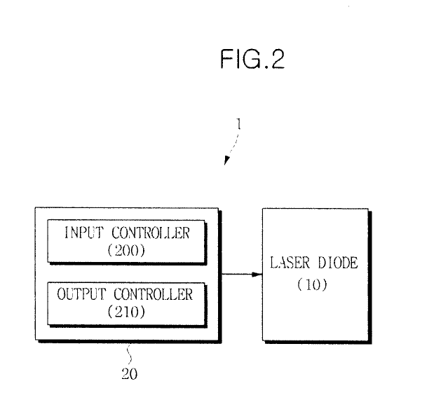

FIG. 2 is a configuration view illustrating an optical transmission apparatus 1 according to an exemplary embodiment. Referring to FIG. 2, the optical transmission apparatus 1 includes a laser diode 10 and a controller 20, wherein the controller 20 includes an input controller 200 and an output controller 210.

The laser diode 10 is a light-emitting device for optical communication, and may be a diode which generates light with a narrow optical spectrum. The generated light is used as seed light. The laser diode 10 emits a laser beam when a predetermined current level called threshold current Ith passes through the laser diode 10 to sharply increase an optical output.

The controller 20 applies a DC bias current and an RF signal to the laser diode 10, and thus dithers an optical signal to be output in a manner to spread the frequency of the optical signal with the RF signal. Then, the controller 20 drives the laser diode 10 at the threshold current level of the laser diode 10 to cause the laser diode 10 to output a dithered optical signal. Consequently, through a small RF dithering, the optical spectrum of the laser diode 10 may be spread.

Meanwhile, the input controller 200 splits an RF signal generated by an RF source by the number of optical channels, and applies the split RF signals and the DC bias current to the laser diode 10 at the threshold current level of the laser diode 10.

The output controller 210 combines optical signals output according to wavelength when the input controller 200 applies the RF signal and DC bias current to the laser diode 10, and uses the combined optical signal as seed light.

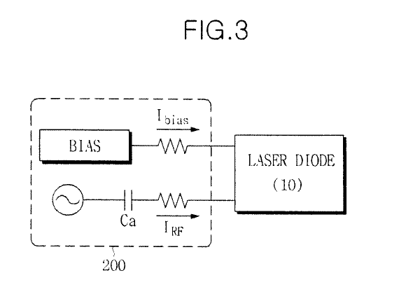

FIG. 3 is a configuration view illustrating the input controller 200 of the optical transmission apparatus illustrated in FIG. 2.

Referring to FIG. 3, the input controller 200 applies both an RF current I_{RF} generated by the RF source and a bias current I_{bias} to the laser diode 10. The RF current I_{RF} is a sine-wave signal having a predetermined frequency and amplitude. If the DC bias current I_{bias} and RF current I_{RF} are applied to the laser diode 10, the optical spectrum of the laser diode 10 is broadened by the frequency chirp characteristics of the laser diode 10. The broadened optical spectrum of the laser diode 10 makes an optical link less vulnerable to reflection induced noise, resulting in an improvement in stability and reliability of the optical link.

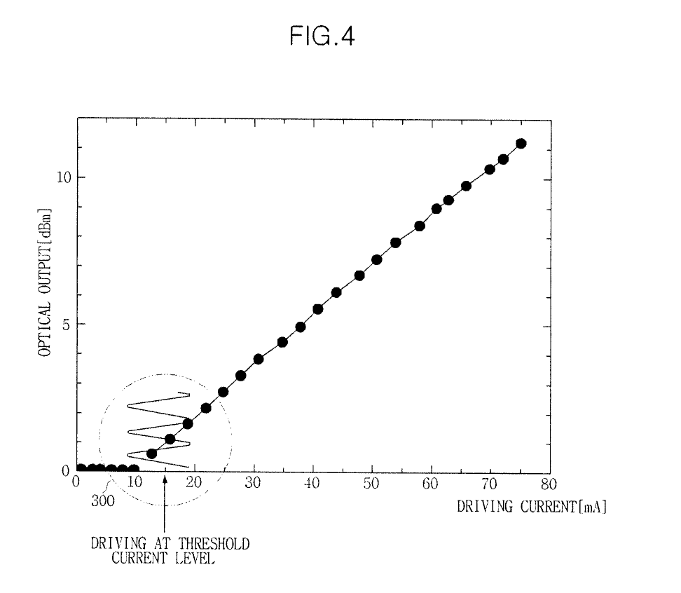

FIG. 4 is a graph showing optical output with respect to driving current to explain a process of broadening an output spectrum by outputting optical signals at a threshold current level of a laser diode, according to an exemplary embodiment.

Generally, different types of laser diodes may create different line widths of output spectrums although the same RF signal is applied to the different types of laser diodes. Moreover, in order to broaden the optical spectrum of a laser diode through dithering, the amplitude of an RF signal is required to be increased. However, applying an RF signal with a large amplitude to each of laser diodes installed for respective channels is inefficient in an optical network.

Accordingly, the current embodiment proposes a method of operating a laser diode at a threshold current level in order to effectively broaden the optical spectrum of the laser diode by applying an RF signal with a small amplitude. That is, the optical transmission apparatus 1 illustrated in FIG. 2 checks a threshold current level of a laser diode and applies a DC bias current I_{bias} and an RF current I_{RF} to the laser diode near the threshold current level, thereby creating an optical signal with a broadened optical spectrum.

For example, referring to FIG. 4 which is a graph showing optical output with respect to driving current where the X axis is driving current and the Y axis is optical output, the laser diode is driven near 10 mA which is a threshold current level of the driving current (see a reference number 300), and generates an optical signal. Accordingly, the laser diode can be driven with low RF power, so efficiency of consumption power can be improved.

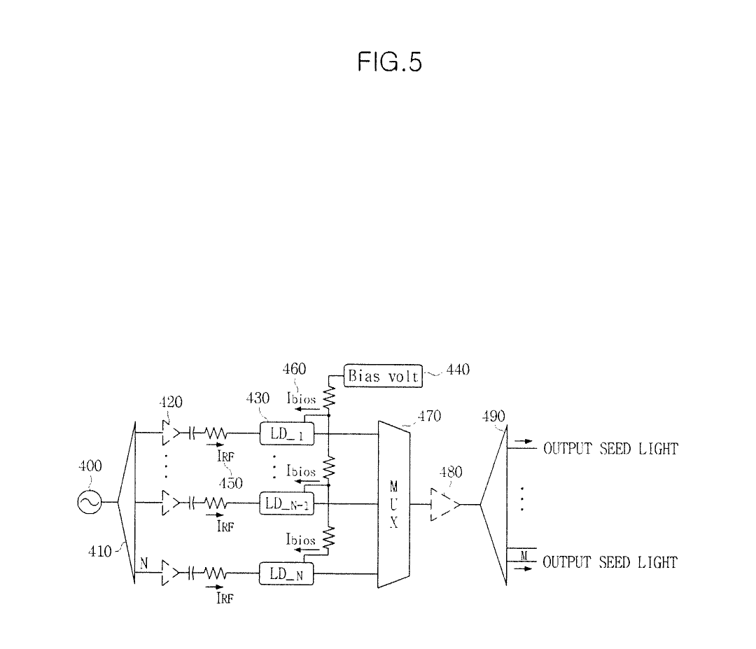

FIG. 5 is a circuit diagram illustrating an optical transmission apparatus according to an exemplary embodiment. The circuit configuration of the optical transmission apparatus is based on a single light source, for example, a DFB-LD array.

Referring to FIG. 5, the DFB-LD array includes an RF signal generator 400, an RF signal distributor 410, a multiplexer (MUX) 470 and an optical distributor 490. In addition, the DFB-LD array may further include an RF amplifier 420 and an optical amplifier 480.

The RF source 400 generates a sine-wave signal having a predetermined frequency and amplitude, for example, an RF signal. The RF source 400 may be an oscillator. The RF distributor (an RF 1×N splitter) 410 splits the output of the RF source 400 by the number N of wavelength channels of a corresponding passive optical network. Each split RF current 450 is applied to a laser diode 430 with a DC bias current 460 generated by a bias voltage 440, thereby broadening the optical spectrum of a single mode laser.

The DFB-LD array may amplify an RF signal split by the RF distributor 410 using the RF amplifier 420. Consequently, a circuit which can apply an amplified RF current 450 and a DC current 460 to the laser diode 430 is implemented.

Meanwhile, according to another exemplary embodiment, since the DFB-LD array is driven at the threshold current level of the laser diode 430, the laser diode only requires a small amount of DC current. Accordingly, the optical transmission apparatus is allowed to have a simple circuit configuration, as illustrated in FIG. 5, which can only adjust resistance.

Meanwhile, the MUX 470 combines different output wavelengths of the optical outputs of the laser diode 430, and uses the combined output as seed light.

When the optical output value processed by the MUX 470 is too small to be used as seed light, the optical amplifier 480 may amplify the optical output value. At this time, the amplified optical output value is split by the number M of systems through the optical distributor 490, and the split optical outputs are used as seed light of downlink or uplink signals for multiple systems.

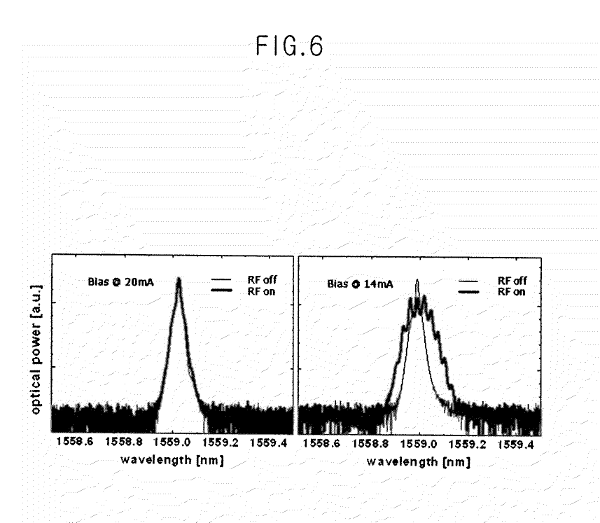

FIG. 6 shows a broadened output spectrum according to an exemplary embodiment.

It can be seen in FIG. 6 that when a laser diode, for example, a DFB-LD is driven at a threshold current level, the optical spectrum is broadened using only a small amount of RF power. For example, referring to a graph shown in the right side of FIG. 6, it is seen that when a bias current is 14 mA, the optical spectrum of the laser diode is broadened by application of the bias current and RF current of 8 mA.

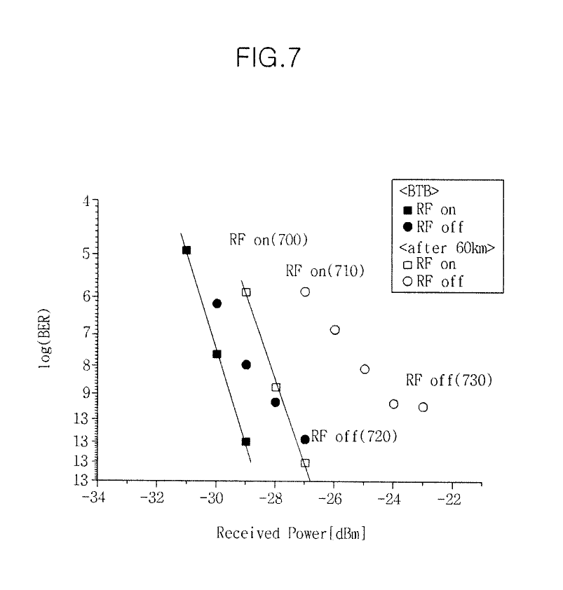

FIG. 7 is a graph showing bit error rate with respect to received power when a laser diode having a broadened optical spectrum is used as a seed light source, according to an exemplary embodiment. The graph shown in FIG. 7 shows the BER with respect to received power in a loop-back WDM-PON where a DFB-LD is used as a seed light source.

FIG. 7 shows a BER curve obtained when a DFB-LD whose optical spectrum is broadened by applying an RF signal is used as a seed light source for RSOA in an optical link with reflection induced noise of about −32 dB, and a BER curve obtained when a general DFB-LD with a narrow optical spectrum is used as a seed light source. Downlink transmission qualities can be determined through comparison between the BER curves shown in FIG. 7.

In FIG. 7, closed squares and circles correspond to the BER when a transmission distance is 0 km and open squares and circles correspond to the BER after transmission of 60 km. When a DFB-LD with a narrow optical spectrum is used as a seed light source in an optical link with reflection induced noise (720 and 730), error flow occurs regardless of transmission distance. In this state, if an RF signal proposed in this specification is applied to the DFB-LD which is a seed light source to broaden the optical spectrum (700 and 710), transmission quality is improved.

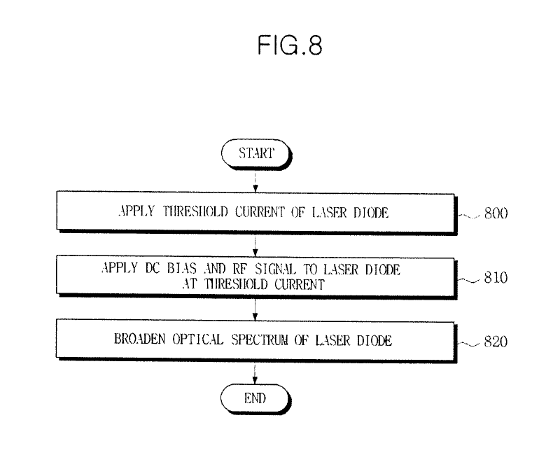

FIG. 8 is a flowchart of an optical transmission method according to an exemplary embodiment.

Referring to FIGS. 2 and 8, the optical transmission apparatus applies a threshold current to the laser diode (operation 800). Then, the optical transmission apparatus applies a DC bias current and an RF signal to the laser diode at the threshold current level (operation 810) to broaden the optical spectrum of the laser diode (operation 820). At this time, the RF signal is generated by the RF source and is split by the number of optical channels and then the split RF signal is applied to the laser diode with the DC bias current.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself.

What is claimed is:

1. An optical transmission apparatus comprising:
a laser diode to generate an optical signal and use the optical signal as seed light; and
a controller to output the optical signal by applying a DC bias current and an RF signal to the laser diode at a threshold current level of the laser diode, thereby broadening an optical spectrum of the laser diode.

2. The optical transmission apparatus of claim 1, wherein the controller comprises:
an input controller to split an RF signal generated by an RF source by the number of optical channels, and apply the split RF signal and the DC bias current to the laser diode at the threshold current level of the laser diode; and
an output controller to combine optical signals output according to wavelength in response to the application of the RF signal and the DC bias current, and use the combined optical signal as the seed light.

3. The optical transmission apparatus of claim 2, wherein the output controller broadens the optical spectrum by spreading/modulating a frequency of an optical signal to be output using the RF signal.

4. The optical transmission apparatus of claim 2, wherein the input controller comprises an RF amplifier to amplify the split RF signal, and the input controller applies the RF signal amplified by the RF amplifier and the DC bias current to the laser diode at the threshold current level of the laser diode.

5. The optical transmission apparatus of claim 2, wherein the output controller comprises an optical amplifier to amplify the combined optical signal, and the output controller uses the optical signal amplified by the optical amplifier as the seed light.

6. The optical transmission apparatus of claim 1, wherein the laser diode is configured using a single light source.

7. The optical transmission apparatus of claim 6, wherein the laser diode is a distributed feedback laser diode (DFB-LD).

8. A loop-back wavelength division multiplexing passive optical network (WDM-PON) system comprising:
a laser diode to receive a DC bias current and an RF signal, and to output an optical signal at a threshold current level of the laser diode, thereby broadening an optical spectrum; and
an optical line terminal including a reflective semiconductor optical amplifier to use the optical signal as seed light and an optical receiver to externally receive an optical signal.

9. The loop-back WDM-PON system of claim 8, wherein the DC bias current and split RF signals obtained by splitting an RF signal generated by an RF source by the number of optical channels are applied to the laser diode at a threshold current level of the laser diode, to spread/modulate a frequency of the optical signal, thereby broadening the optical spectrum.

10. The loop-back WDM-PON system of claim 8, wherein the laser diode is configured using a single light source.

11. An optical transmission method comprising:
applying a threshold current level of a laser diode; and
applying a DC bias current and an RF signal to the laser diode at the threshold current level to broaden an optical spectrum of the laser diode.

12. The optical transmission method of claim 11, wherein the broadening of the optical spectrum of the laser diode comprises splitting an RF signal generated by an RF signal source by the number of optical channels and applying the split RF signals and the DC bias current to the laser diode.

13. The optical transmission method of claim 11, wherein the broadening of the optical spectrum of the laser diode comprises combining optical signals output according to wavelength in response to the application of the RF signal and the DC bias current, and using the combined optical signal as seed light.

14. The optical transmission method of claim 11, wherein the laser diode is configured using a single light source.
